(19) United States
(12) Patent Application Publication
(10) Pub. No.: US 2004/0219496 A1
(43) Pub. Date: Nov. 4, 2004

(54) Interactive educational system

(76) Inventor: P.K. Stevinson, Littleton, CO (US)

Correspondence Address: Glenn L. Webb, P.O BOX 951, Conifer, CO, 80433, US

(21) Appl. No.: 10/427,147

(22) Filed: Apr. 29, 2003

(51) Int. Cl. G09B 1/00

(52) U.S. Cl. 434/159

(57) ABSTRACT

An interactive system for teaching young children fundamentals and basic skills. The system of a preferred embodiment provides toys that have components for teaching young children fundamentals such as colors, shapes, numbers and letters as well as basic skills such as grooming, telephone use, time-telling and dexterity and associative skills. The learning occurs through combined modalities of visual, auditory and kinesthetic learning. The system encourages active participation of parents and other caregivers in an environment that will enhance maximization of their time with their children.

### FIELD OF THE INVENTION

This invention relates to the field of educational systems for preschool children.

### BACKGROUND OF THE INVENTION

Education of young children is of ever increasing importance. Often, the education process does not begin until the child enters kindergarten or even elementary school. However, there are important fundamentals for all children to grasp that will enhance the formal education process and that will encourage the child to learn once they enter kindergarten or elementary school. These fundamentals include colors, shapes, letters and numbers. The grasp of these fundamentals greatly improves the ability and motivation for the child entering into kindergarten. Studies have shown that early “pre-education” of such fundamentals by a child correlate with the advancement of the child in later classes.

Another area of education of young children is the learning of basic skills. These skills can include grooming basics, telling time, using the telephone, the basics of money and may other items that are useful basic skills. The teaching of these skills at an early age will give children an advantage in self-sufficiency.

Pre-education of children requires the time and interaction of the parents or caregiver of the child. Typically, parents have limited amounts of time that they can spend interacting with their preschool children. This time is usually devoted to the care of the children as well as playing with the children. There is little time usually for teaching the children the above-mentioned fundamentals and skills.

Another problem with teaching of children is the different modalities that children may require in order to learn. For example, some children learn better through audio instruction, such as hearing the instructional materials. Others learn better by visual learning, that is by seeing the instructional materials. Still others may learn better by kinesthetic instruction, that is by performing or doing the learning activities. Most children learn best by combinations of these types of learning. However, many instructional materials are oriented to only one of these modalities.

Traditional fundamental learning materials tend to be oriented towards an instructor-classroom style of teaching. Most pre-school children do not have the attention span necessary for such instruction. This causes a problem with the desire of the child to learn these fundamentals and skills as well as their ability to stay focused on the material being taught.

These and other problems have created a need for a system that will enable young children to be pre-educated in the fundamentals as well as in basic skills through the use of combined modalities as well as to enable parents and other caregivers to facilitate this learning process despite limited time availability.

### SUMMARY OF THE INVENTION

The present invention solves these and other problems by providing an interactive teaching system. This system provides instruction to young children in a play environment that will keep the attention of the children focused on the education process. The system of a preferred embodiment of the present invention provides instruction to preschool children in the basic fundamentals of shapes, colors, numbers and letters as well as basic skills. These fundamentals and skills will improve the learning process for these young children as they enter the formal school process in kindergarten and elementary school.

The preferred embodiment of the present invention provides a system of interactive education that uses toys that in themselves will be enjoyed by the children. These toys also include components that will enable the learning of the basic fundamentals and skills during the interaction of the child and the toys at play.

The toys of the preferred embodiment will enable a child to learn not only through one modality but through combined modalities to increase the learning process. The child will learn through visually watching the toys and the interaction with an instructor or other children, through auditory learning by listening to stories and descriptions of the fundamentals, and through kinesthetic learning by handling the toys themselves.

The system of the preferred embodiment provides toys that have brightly colored segments that will enable the teaching of the primary and secondary colors. Other components of the system provide toys that include numbered segments that will enable the learning of the numbers, segments of differing shapes to enable identification of the primary and secondary shapes and segments with alphabetic letters to enable naming of the letters as well as simple words. These segments may be combined together in toys as well.

The system also improves dexterity and associative skills by providing detachable segments. The dexterity of the child will be improved by reattaching the segments. Additionally, the associative skills are improved by encouraging the child to reattach the segment in an appropriate location.

Another feature of a preferred embodiment of the present invention is the learning of basic skills by a child. Toy components that will teach grooming skills, telephone skills, time-telling skills, dexterity skills as well as other skills are provided. These components teach these skills by the use of visual, auditory and kinesthetic learning components.

A preferred embodiment of the present invention also includes the features of an instructional manual that will prompt an instructor on characteristics of each toy component, such as its name, personality traits, voice characteristics and other features that will enhance not only the learning process but to increase the fun factor for the children as well as the instructor.

The system of a preferred embodiment of the present invention enables parents and other caregivers to maximize their time with their children through combined play and education of the child.

These and other features of the present invention will be evident from the ensuing description of preferred embodiments and from the drawings.

### BRIEF DESCRIPTION OF THE DRAWINGS

FIG. 1 is an illustration of a toy component of the system of a preferred embodiment of the present invention teaching fundamental colors and numbers.

FIG. 2 is another illustration of the toy component of FIG. 1.

FIG. 3 is an illustration of another toy component of the system of a preferred embodiment of the present invention teaching fundamental shapes, colors and letters.

FIG. 4 is an illustration of the back of the component of FIG. 3.

FIG. 5 is an illustration of the component of FIG. 3 separated into individual segments.

FIG. 6 is an illustration of another component of the system of a preferred embodiment of the present invention teaching grooming skills.

FIG. 7 is an illustration of the component of FIG. 6 in the open position.

FIG. 8 is an illustration of a component of the system of a preferred embodiment for teaching telephone skills.

FIG. 9 is another view of the component of FIG. 8.

FIG. 10 is an illustration of a component of the system of a preferred embodiment for teaching time skills.

FIG. 11 is an illustration of another view of the component of FIG. 10.

FIG. 12 is an illustration of a component of the system of a preferred embodiment illustrating body parts.

FIG. 13 is an illustration of a component of the system of a preferred embodiment teaching money and currency skills.

FIG. 14 is an illustration of a component of the system of a preferred embodiment teaching geography skills.

FIG. 15 is an illustration of a component of the system of a preferred embodiment teaching geography skills.

FIG. 16 is an illustration of a component of the system of a preferred embodiment teaching color and number skills.

FIG. 17 is an illustration of a component of the system of a preferred embodiment teaching dexterity skills.

FIG. 18 is another view of the embodiment of FIG. 18.

FIG. 19 is an illustration of a component of the system of a preferred embodiment providing instructional materials.

FIG. 20 is an illustration of a component of the system of a preferred embodiment teaching reference material skills.

FIG. 21 is an illustration of a component of a system of another preferred embodiment for teaching dexterity skills in small children.

FIG. 22 is an illustration of another toy component of the system of FIG. 21 for teaching grooming skills.

FIG. 23 is an illustration of another toy component of the system of FIG. 21 for teaching time telling skills.

FIG. 24 is an illustration of another toy component of the system of FIG. 21 for teaching storage and organizing skills.

FIG. 25 is an illustration of another toy component of the system of FIG. 21 for teaching directional skills.

FIG. 26 is an illustration of another toy component of the system of FIG. 21 for teaching telephone skills.

FIG. 27 is an illustration of a component of the system of a preferred embodiment teaching lifestyle skills.

FIG. 28 is an illustration of a component of a system of embodiment of FIG. 27 for teaching lifestyle skills.

FIG. 29 is an illustration of another toy component of the system of FIG. 27.

FIG. 30 is an illustration of another toy component of the system of FIG. 27.

FIG. 31 is an illustration of another toy component of the system of FIG. 27.

FIG. 32 is an illustration of another toy component of the system of FIG. 27.

FIG. 33 is an illustration of another toy component of the system of FIG. 27.

FIG. 34 is an illustration of another toy component of the system of FIG. 27.

FIG. 35 is an illustration of another toy component of the system of FIG. 27.

FIG. 36 is an illustration of another toy component of the system of FIG. 27.

FIG. 37 is an illustration of another toy component of the system of FIG. 27.

FIG. 38 is an illustration of another toy component of the system of FIG. 27.

FIG. 39 is an illustration of another toy component of the system of FIG. 27.

FIG. 40 is an illustration of another toy component of the system of FIG. 27.

FIG. 41 is an illustration of another toy component of the system of FIG. 27.

FIG. 42 is an illustration of another toy component of the system of FIG. 27.

FIG. 43 is an illustration of another toy component of the system of FIG. 27.

### DETAILED DESCRIPTION OF PREFERRED EMBODIMENTS

The present invention provides a system for the interactive education of children, such as preschool children, in fundamentals and other skills. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the components of the system are discussed, other equivalents to these embodiments that perform substantially similar functions are within the scope of the claimed inventions.

The education system of a preferred embodiment of the present invention provides interactive education of children in fundamentals that will prepare them for entering into kindergarten, elementary school, home-schooling or other educational environments. The system of this preferred embodiment enables caregivers to maximize their time with children by combining their education with activities designed to be fun for the children as well as their caregivers. The system also provides learning in different modalities simultaneously to enhance the child's learning experience. The system allows children to be taught through audio, visual and kinesthetic learning styles, encourages the participation by the caregivers, and provides the children with basic fundamentals that will enhance their later learning processes.

The education system of this preferred embodiment uses unique toys as components for the learning process. These toys, by themselves, are designed to be fun as play items for the children. However, these toys also provide important education components for learning of fundamentals, such as colors, shapes, letters and numbers, as well as basic skills, such as grooming, telephone and other useful life skills for young children. The interaction of these toys with the children and adults, such as parents, caregivers and others, enable the children to learn these important and useful fundamentals and skills.

These unique toys are, in this preferred embodiment, formed of plush, colorful, child-safe materials. It is to be expressly understood that other materials may be used as well. Several embodiments of these toys are discussed below for descriptive purposes only, and not to limit the scope of the claimed invention to these particular embodiments. The claimed invention covers other embodiments of toys as well, particularly those that enable the basic fundamentals of color, shapes, letters and numbers, as well as skills to be taught through a combined modality learning style as well as combining play and instruction in an interactive environment.

In a particular preferred embodiment, the toy components of the system of the present invention also includes instructional materials that provide helpful information regarding the toys, their names, identities, characteristics as well as voice styles suitable for these toys. This creates an environment that will help the children to interact more in the process.

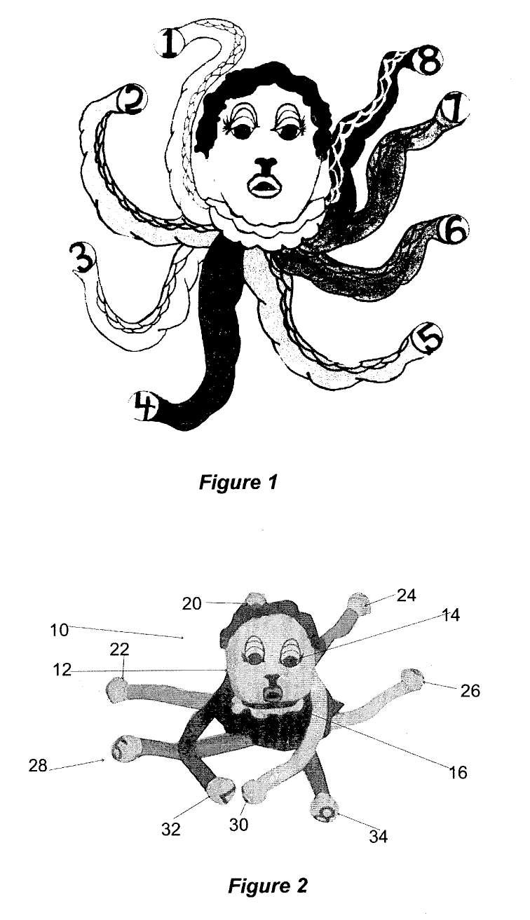

One component of a preferred embodiment of the present invention is illustrated in FIGS. 1 and 2. The toy 10 of this embodiment includes an upper doll head 12 having a face portion 14, a body portion 16 and a series of flexible legs 20-34. Each of the flexible legs 20-34 are numbered 1-8, respectively, and are of differing colors making up the primary and secondary color wheels. The toy can be given a name and identity. In this preferred embodiment, the toy is formed from bright, plush, soft fabrics that are safe for toddlers up to children of any age.

Each of the components of the primary color wheel (red, yellow, blue) and the secondary color wheels (orange, violet, green) can be easily taught by through the use of the toy 10. The names associated with the colors are easily taught to the child as the child and the person providing the instruction during play with the toy. The child, if appropriate, can also be taught the primary colors and secondary colors and their interaction.

The child may also be taught numbers as well. Each leg has a number associated with it on the end of the leg. The names can be identified with particular numbers. As the child advances, simple quantative analysis skills can be taught by example through the use of the legs of the toy, such as addition and subtraction, if appropriate. Again, the instruction is taking place as an interactive activity during play with the toy.

Each of the legs 20-34 are separable and attachable to the body portion 16. The attachment may be by way of hook and loop fasteners, or by other available fastening mechanisms. The ability to detach and reattach the legs to the body of the toy provides a number of benefits. The exercise of detaching and reattaching the legs improvise the dexterity of the child in handling the components. Further, the cognitive skills of the child are also improved in the associative tasks in attaching the legs to the body as well as remembering the sequence of the attachment of particular legs to particular portions of the body.

In another preferred embodiment of the present invention, a toy (not shown) similar to the above described embodiment includes additional separable segments on the legs. These segments are individually colored in the primary and secondary colors. Different combinations of the segments can be used to teach how the colors can be combined to form other colors. The body is also formed of different secondary colors. The attachment of the different segments to the created secondary color of the body provides instruction as to this process. Also, the attachment process also improves dexterity and associative skills.

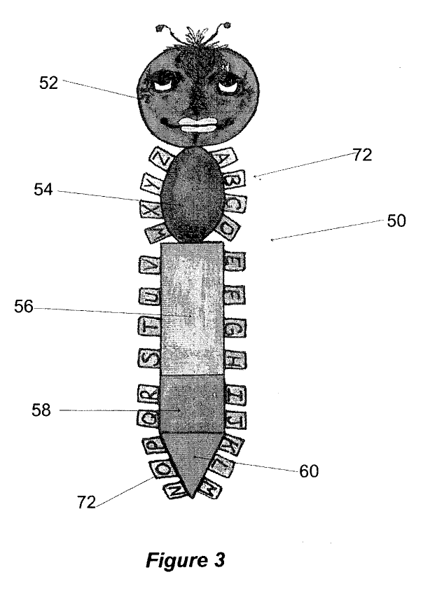

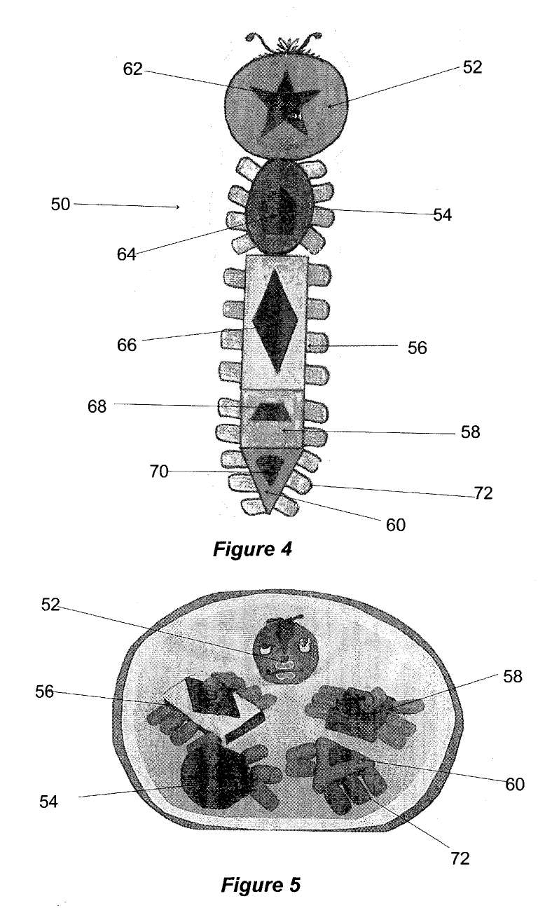

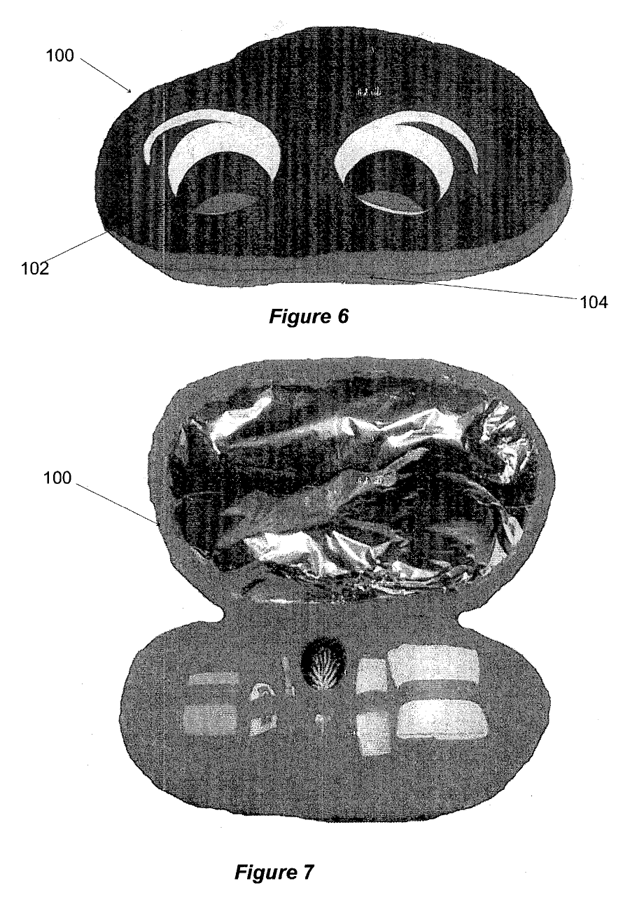

Another example of the interactive toys used in the present system is illustrated in FIGS. 3-5. This toy 50 has a generally centipede shape, and is formed from brightly colored, soft, plush child-safe materials. The centipede is formed a plurality of shaped segments 52, 54, 56, 58 and 60, each colored, and with a plurality of geometric shaped emblems 62, 64, 66, 68, 70 on the reverse side of the individual segments. Legs 72 are attached to the body segments with alphabetic characters on each of the legs 72. As shown in FIG. 6, the segments are removably attached to one another by hook and loop fasteners or by other fastening mechanisms.

Each of the segments 52, 54, 56, 58, 60 is formed in a primary shape, such as a circle, oval, square, rectangle, and triangle. On the back of each of the segments, as shown in FIG. 5, are secondary geometric shapes star 62, pentagon 64, diamond 66, trapezoid 68 and cone 70. The legs 72 may be removably attached as well to allow words to be formed from different letters.

This toy has particular applicability to teaching the primary shapes, colors and for learning letters and even for creating simple words. The child is taught through visual perception of the shapes, colors and letters, through auditory learning by the instructor speaking the names of the shapes, colors and letters, and by kinesthetic/tactile handling of the individual and combined segments. The instruction occurs through interaction of the child and the toys along with interaction by the instructor, such as a parent or other caregiver and other children.

The child also improves skills such as dexterity as well as cognitive skills by associating the individual segments with the overall structure of the toy and attaching and detaching the segments from one another. This learning process occurs in a fun, playful environment so the child stays interested and focused on the process.

Another component of the preferred embodiment of the present invention is illustrated in FIGS. 6 and 7. This toy 100 is shaped as a large soft clam having facial features 102, 104 attached thereto. The toy 100 is formed of brightly colored plush soft child safe materials that can be used as a soft huggable pillow. The pillow toy is opened up in a clam-like fashion to allow access to grooming materials as shown in FIG. 7. The grooming materials can include such items as hairbrush, toothbrush, toothpaste, soap, brush and other items of personal hygiene. The instructor can in a play environment provide instruction as to the use of each of the items. The child is taught such skills by visual perception of the instructor and others using these items, by auditory learning from the instructor describing their use and by kinesthetic learning by using the items themselves. The instruction occurs during play so the child stays interested and focused in the process. Thus, not only are fundamental basics such as colors, shapes, numbers and letters are taught with the present system but also basic skills as well. The toy 100 can also be used as an overnight bag for the child as well.

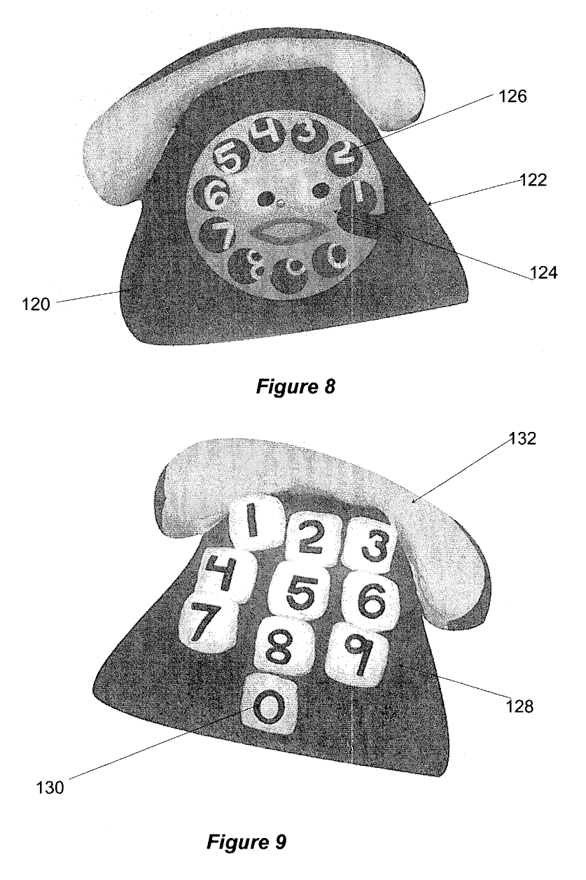

Another component of a preferred embodiment of the present invention is shown in FIGS. 8 and 9. A telephone shaped toy 120 is formed of brightly colored, soft, plush child safe materials. The front 122 of the telephone includes a rotary dial 124 having removable numerals 1, 2 . . . 0. The numerals are soft components that can be easily removed and reattached. The rear 128 of the telephone includes a push button style telephone dialing mechanism having the removable numbers 130 1, 2 . . . 0 displayed. A receiver shaped segment 132 is removably attached to the body of the telephone toy.

The child is instructed on the use of a standard telephone by simulation on the toy 120. The child may be taught through play how to remove the receiver, listen to a dial tone and dial numbers on the telephone. This skill may be particularly useful by teaching the child how to dial emergency numbers such as 911. The child is taught in a playful environment so to stay attentive and interested and by using combined modalities of visual learning by seeing the instructor use the toy, by auditory learning by sharing the instructor demonstrate the process and by kinesthetic learning by actually using the toy to simulate using the telephone. The dexterity and associative skills are also improved by removing the telephone numbers and reattaching in the appropriate sequence.

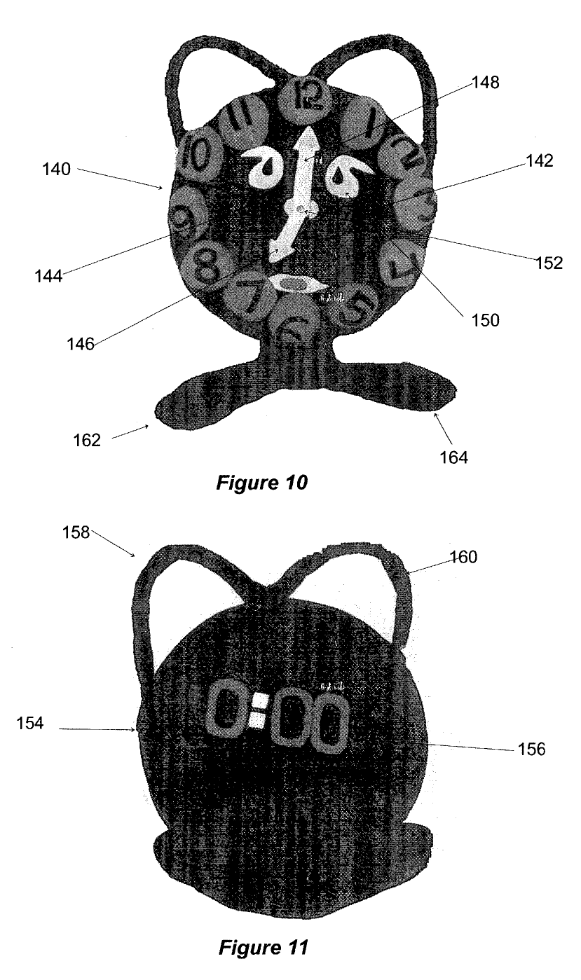

Another skill instruction component is illustrated in FIGS. 10 and 11. The toy 140 is formed in the shape of an alarm clock from soft, plush, child safe materials. The toy 140 includes an analog time clock 144 on the front 142 of the toy. The clock 144 includes removable numerals 1-12 displayed around the perimeter, a little hand 146, a big hand 148, and facial features 150. The hands 146, 148 are pivotable about a central axis 152 to display different times. A digital clock 154 is formed on the rear of the clock. Removable numbers 156 may be fastened by hook and loop fasteners or other fastening mechanisms onto the digital clock. The toy also includes bell-shaped handles 158, 160 for carrying of the clock. The clock toy may also include extendible feet 162, 164 that may be pulled down if desired. This toy may be used to teach time to children through visual learning of watching the instructor, by auditory learning of listening to the instructor and by kinesthetic learning of interactive, hands-on playing with the toy. The dexterity skills are improved by removing and attaching the number components in appropriate locations. This also improves the associative skills of the child as well. The child and the instructor can accomplish this learning process by doing so in a play environment.

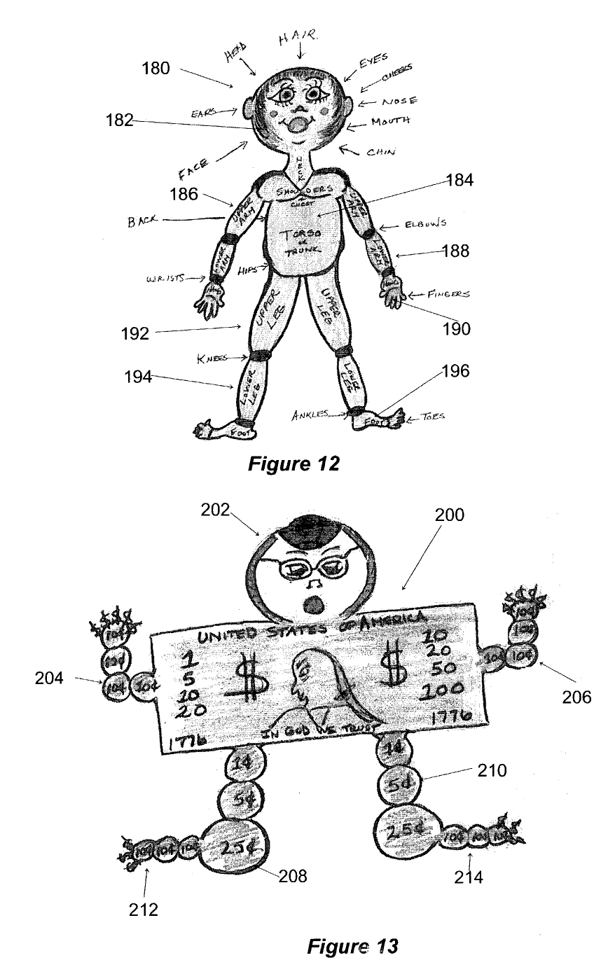

Another educational component is illustrated in FIG. 12. This toy component 180 is formed of a soft, plush, child-safe material in the form of a human body. The toy includes head segment 182, torso segment 184, upper arm segments 186, lower arm segments 188, wrist segments 190, upper leg segments 192, lower leg segments 194 and feet segments 196. Other segments may be included as well. Each of the segments may be labeled and are removably attached to one another. Other body parts may be labeled as well, such eyes, ears, nose, mouth, etc. The labels may be permanent as in the preferred embodiment or may be removable as well.

Children may learn the individual body parts by visually watching the instructor, by auditory listening to the recitation of the body parts and by kinesthetic instruction in handling each of the body parts. They will also improve their dexterity as well as their associative skills by removing and reattaching the body parts onto the toy. This instruction also occurs during a play environment.

Another possible component of the preferred embodiment of the present invention teaches children skills in handling money. As illustrated in FIG. 13, a toy 200 is formed generally in the shape of a paper currency bill from soft, plush child safe materials. The toy 200 includes a head 202 formed from a larger coin, such as a dollar coin, arms 204, 206 of smaller denomination coins, legs 208, 210 of various denomination coins and feet 212, 214 of yet other denomination coins.

In use, children can learn about the concept of currency, the differing denominations of currency, and the concept of making change. Again, a child can learn visually, from watching an instructor or others playing with the toy, auditory by listening to the instructor and others, and kinesthetically by playing with the toy. The different segments may also be removed and reattached to improve associative skills as well as dexterity.

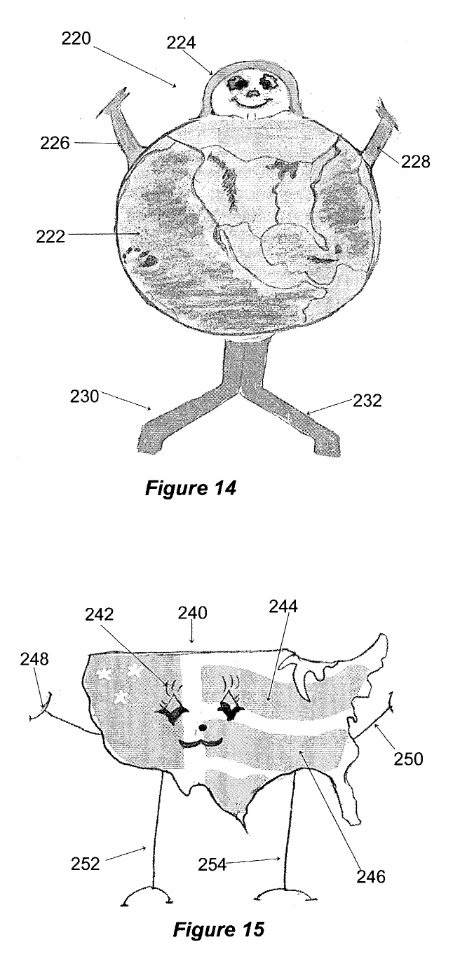

Another possible component to the system of the descriptive preferred embodiment is illustrated in FIG. 14. The toy 220 includes a substantially globe shape formed of soft plush child safe materials. The globe body portion 222 includes the major geographical areas such as continents, oceans, seas, rivers, lakes, mountains, valleys, deserts, tundra, forests and the like. These features may either be permanently attached to the globe body portion 222 or removable. In this particular embodiment, the toy also includes a head 224, arms 226, 228 and legs 230, 232. Again, a child may learn during a play environment by watching an instructor point the different features, by listening to the instructor and by handling the toy themselves. If the features are removable, then the child will also improve physical dexterity as well as cognitive associative skills.

The above component may also be associated with another component, as illustrated in FIG. 15. The toy 240 includes a shape substantially in the form of a country, such as the continental United States. A face 242, or flag 244 may be superimposed over the map body 246. Arms 248, 250 and legs 252, 254 may also be added. The entire toy is formed from soft plush child safe materials. Significant features such as rivers, lakes, mountains or boundaries may be added as well. This toy is used in a similar fashion as the above described toys.

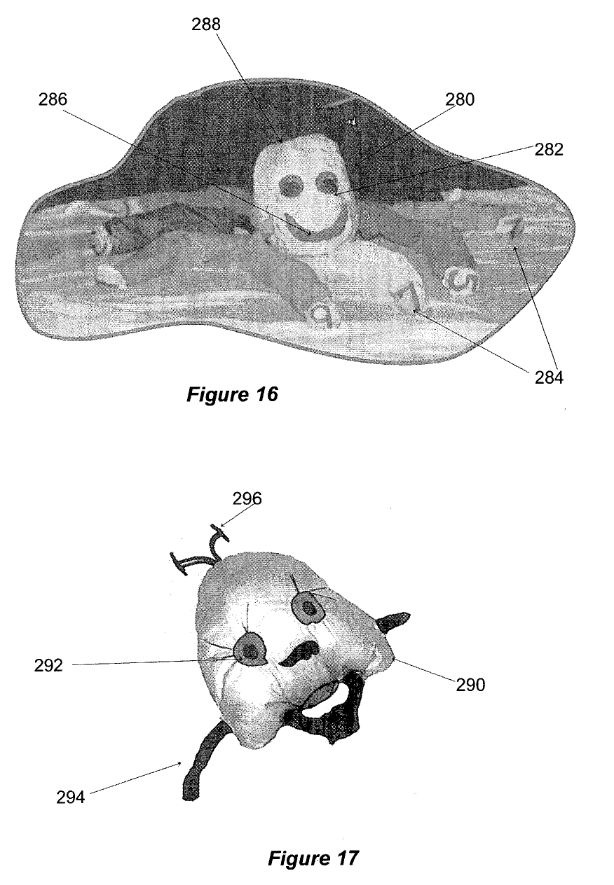

Another possible component to the preferred embodiment is illustrated in FIG. 16. The toy 280 is somewhat similar to the component toy 10 described above in that it includes a body portion 282 having a plurality of brightly individually colored legs 284 that are numbered. This toy also includes a large mouth 286 along with other facial characteristics and a pocket formed in its head for storage. The pocket 288 provides storage, not only for removable components of the toy, but also for associating objects, photographs, and other “memories” that the toy may have. This toy can be used along with the other toys for providing an interactive educational experience in learning colors and numbers as well as cognitive skills as well as for associating memories and objects.

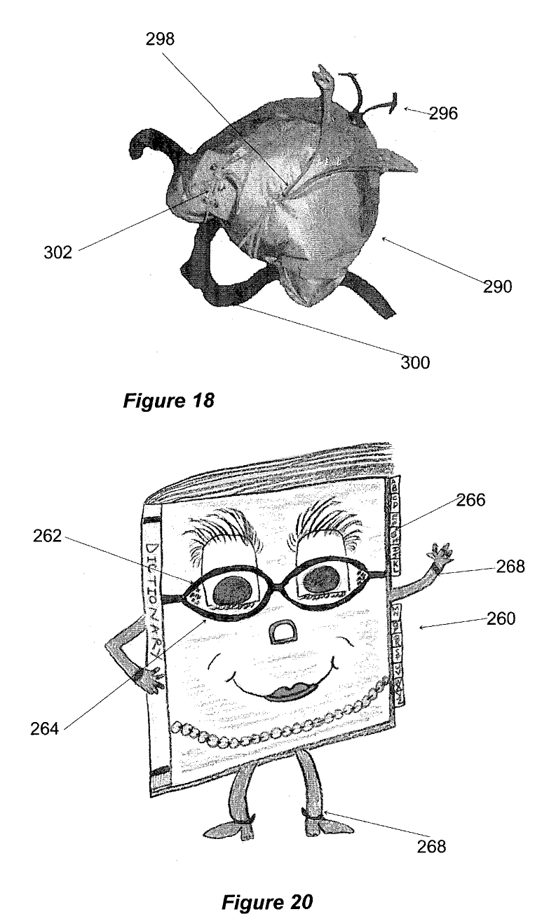

Illustrated in FIGS. 17 and 18 is another possible component of the preferred embodiment of the present invention. Toy 290 includes a substantially “blob” shape of silver or other brightly colored, soft, plush, child safe material. The blob shaped body portion includes a number of items, such as laces, buttons, snaps, zippers, hook and loop fasteners and other such common items. This particular toy is intended to improve the dexterity of the child in manipulating these objects. The child learns to manipulate these items by visually watching the instructor and other children, by listening to explanations as to how manipulate them and by kinesthetically manipulating the items themselves. Again, this is done in a play environment so the child interacts with the toys and the instruction.

As can be readily recognized, the above descriptive embodiments are intended only for explanatory purposes and not to limit the scope of the present invention. Other shapes, colors, segments, materials and the like are within the present invention of using toys capable of instruction through combined modalities in a play environment.

These and other toy components are used for providing young children with fundamentals and skills to enhance their education process. Essentially, the present invention, in the preferred embodiment, enables children to more easily learn by using combined modalities, and in encouraging the children to learn through interaction with the toys and their instructors. The children are also instructed through a play environment to keep their interest focused on the activity and to make the process more enjoyable.

Another benefit of the present invention is to enable parents, other caregivers, older siblings and others the opportunity to interact in the educational process of a young child without sacrificing the other time limitations in raising children in today's hectic environment.

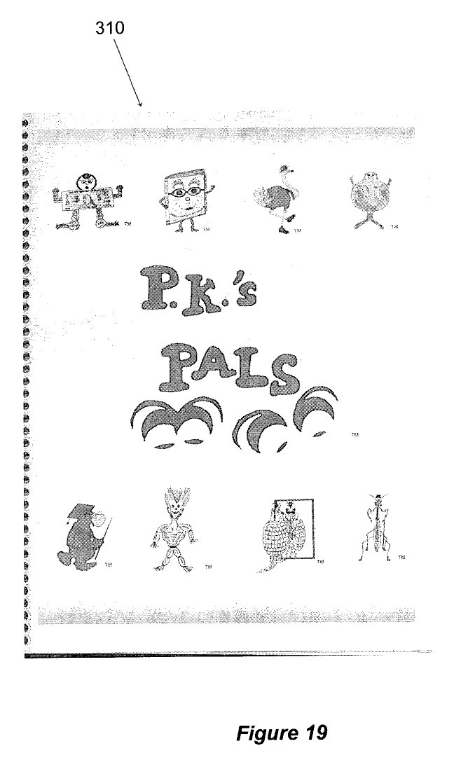

In another preferred embodiment of the present invention, the system as described above is complimented by a manual, such as manual 310 in FIG. 19, outlining the nature of each component toy, its characteristics, providing a name and identity to each toy and providing usage guidelines to instructors on how to apply each toy. The manual may provide voices for emphasizing the auditory connection with the children for each toy so that the toy takes on a unique identity.

Another preferred embodiment of the present invention is intended for use with slightly more advanced children. This embodiment uses toys that are designed for more advanced learning, such as kindergarten through third grade. These toys are used for acquired learning, such as spelling, reading, writing and other basic educational skills. An example of such a toy is illustrated in FIG. 20. This toy 260 is formed in the shape of a dictionary or book from soft plush child safe materials. The body portion 262 includes facial characteristics 264 on its front, and alphabetically labeled flaps 266 on one side. Arms 268 and legs 270 may also be attached to the body portion 262 as well. The body portion opens at each of the alphabetically labeled flaps 266 so that well known words and their common definitions are able to be viewed. This toy is intended for slightly more advanced students, and is intended to create skills in using dictionaries and other reference materials. Also, removable letters can be used by the child or instructor to spell example words. Again, this toy instructs in a play environment by visual, auditory and kinesthetic modalities.

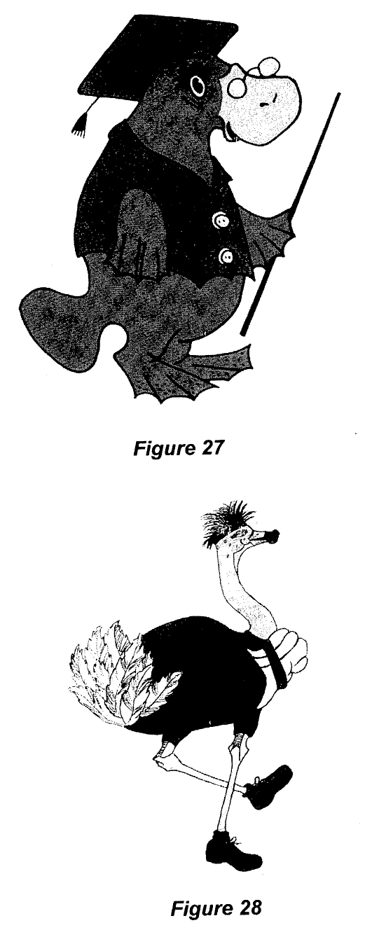

Other examples of the toy components of this system are shown in FIGS. 27 -43. It is to be expressly understood that other toy components that function in a similar manner are also within the scope of the claimed invention, particularly as used in acquired learning skills by use of interactive toys that teach in combined modalities of visual, auditory and kinesthetic. These components are intended for more advanced learning, such as acquired learning, life skills and specialties. For example purposes, the toy of FIG. 27 is intended as an aid for teaching the idea of exploration, adventure and mysteries of the world. The toy is able to dressed in different costumes depending on the direction of education being pursued. Instructions as to the personality and voice of this character are included.

The toy of FIG. 28 is another example of the learning aids provided by this system for additional acquired learning skills. This particular toy is used to teach, using different costumes, such things as sports, fitness to manners and elegance.

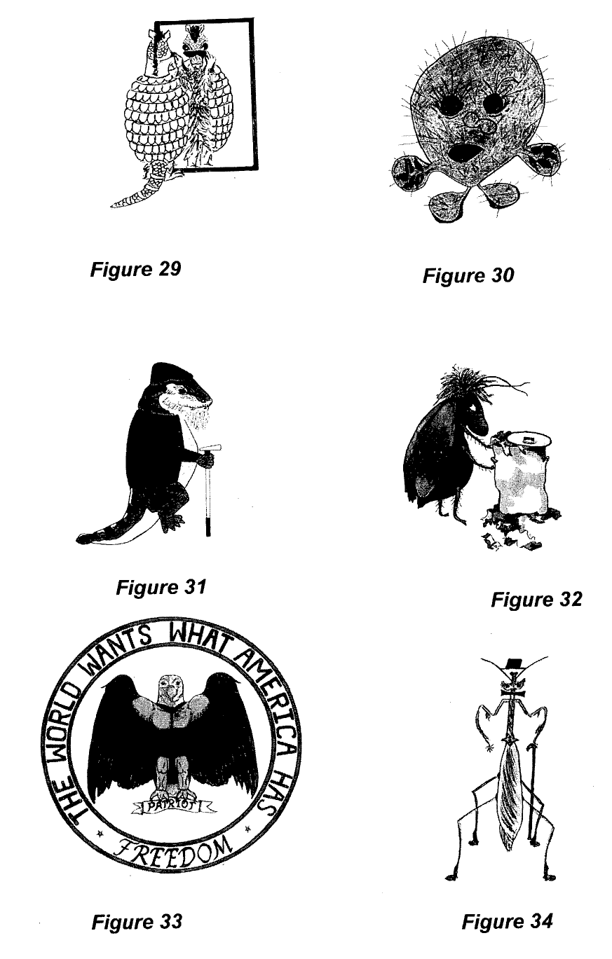

Another toy embodiment under this system is shown in FIG. 29. This toy includes different shells, vests, coats etc. to demonstrate the ability to change into different life styles and ventures.

The toy shown in FIG. 30 also includes various toys to demonstrate the ability of tradesmen, craftsmen, artisans and others who are able work skillfully with their hands. Similarly, the toy shown in FIG. 31 demonstrates through different costumes the craft of storytelling and philosophy. Another personality is demonstrated in the toy of FIG. 32 of underachievement through a disreputable insect shape. The toy of FIG. 33 demonstrates values and patriotism and the rule of law. Manners and courtesies are teachable using the toy of FIG. 34.

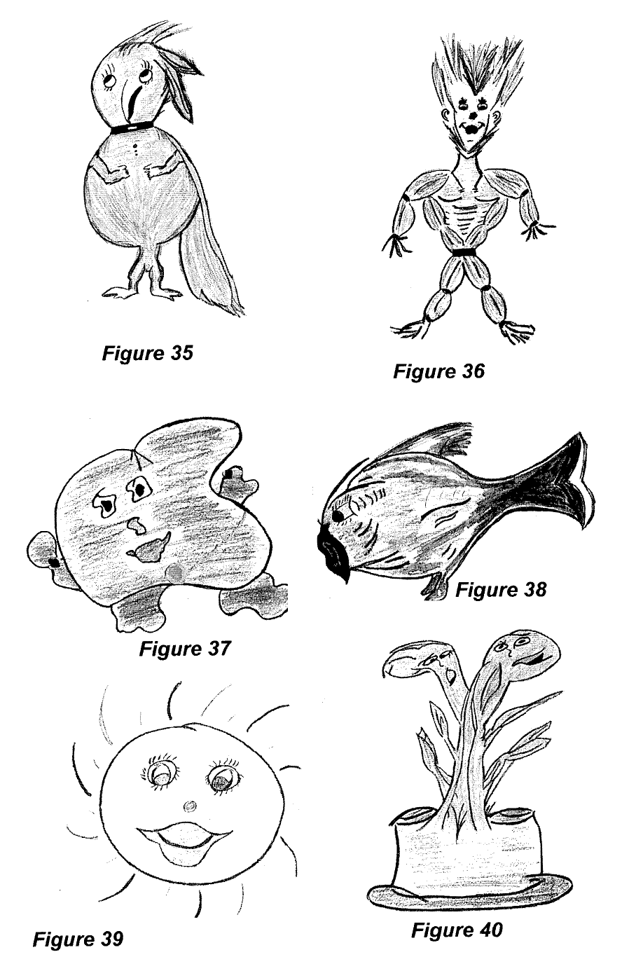

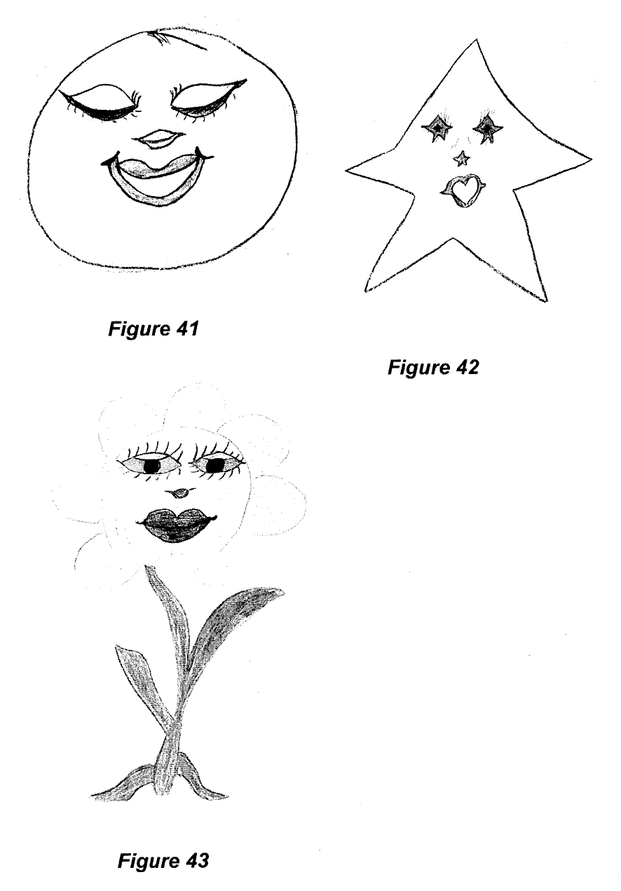

Other values such as spirituality, compassion, and the like are taught using the toy of FIG. 35. Dietary education is supplied using the toy of FIG. 36. Geology may be taught using the toy of FIG. 37. Sea creatures and other waterborne creatures are learned using the toy of FIG. 38. The solar system may be taught using the toy of FIG. 39. Horticulture and botany may be demonstrated using the toy of FIG. 40. The moon may be discussed using the toy of FIG. 41. Stars may be discussed using the toy of FIG. 42. Flowers and herbs are taught using the toy of FIG. 43. These and other toys are used in the system of this preferred embodiment to discuss more advanced levels of acquired learning by using the combined modalities of visual, auditory and kinesthetic learning approaches in an interactive environment.

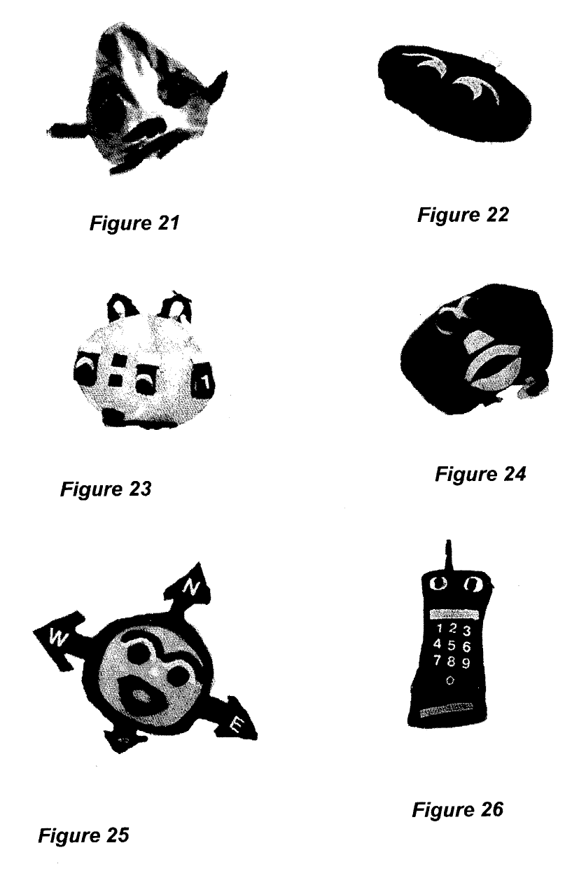

Another preferred embodiment of the present invention is intended for younger children, even toddlers. This embodiment is particularly useful for teaching basic skills and possibly some fundamentals to these children. The system of this embodiment uses smaller toys that are more suitable for these younger children. These toys are able to be used at a more basic level than the component toys of FIGS. 1-20. Examples of these toys are illustrated in FIGS. 21-25. These toys typically teach only one fundamental or skill at a time, and are smaller and able to handled by small children. The child however is able to learn through visual, auditory and kinesthetic modalities as discussed in the earlier embodiments.

An example of a toy of this embodiment is illustrated in FIG. 21. This brightly colored “blob” formed from plush child safe materials. This toy includes a dexterity function on its backside, such as zipper, lace, buckle, hook and loop fastener or some other type of mechanism that will allow the child to improve it's dexterity. The child can learn by watching, listening and by handling the mechanism.

Illustrated in FIG. 22 is another example of a toy component of this embodiment. This toy is brightly colored formed from plush, child-safe materials and has an opening in its belly. A grooming aid is kept in this opening, such as a comb, brush, toothbrush, or other item. The child is able to learn a particular grooming skill from this toy through watching an instructor or other children, listening to the instructor and by handling the toy and aid.

Another toy component of this embodiment is illustrated in FIG. 23. This toy is shaped as a digital clock from plush child-safe materials. Removable numerals are placed on the eyes of the toy to teach telling of time.

The toy component shown in FIG. 24 includes a pouch for storage of items. The child can learn basic skills of putting away items for storage with this toy by watching and listening to instruction and by putting items away and taking them out of the pouch.

Another toy component of this embodiment is shown in FIG. 25. This toy includes compass points and is formed from plush child-safe materials. This toy teaches directions and the concept of North, South, East and West.

Another embodiment is shown in FIG. 26. This toy component is a soft, plush child-safe telephone shaped toy. The child can learn dialing and other telephone skills from this toy.

The present invention of a system for interactive education for teaching young children fundamentals and skills include not only the above descriptive embodiments but other variations and embodiments within the claimed inventions.

What is being claimed is:

1. An interactive educational system for children, said system comprising:
a children's toy having at least one component;
said at least one component providing instruction regarding one or more fundamentals through interaction with an instructor;
said fundamentals including one or more of the following: colors, shapes, letters and numbers;
said instruction including instructional materials with auditory, visual and kinesthetic learning modalities; and
said at least one component formed of a plush material safe for use by children.

2. The system of claim 1 wherein said system further comprises:
said at least one component providing instruction regarding one or more skills.

3. The system of claim 1 wherein said system includes:
said at least one component having colored segments to enable teaching of the primary colors.

4. The system of claim 1 wherein said system includes:
said at least one component having colored segments to enable teaching of the secondary colors.

5. The system of claim 1 wherein said system includes:
said at least one component having segments that enable teaching of the numbering system.

6. The system of claim 1 wherein said system includes:
said at least one component having segments that enable teaching of the alphabet system.

7. The system of claim 1 wherein said system includes:
said at least one component having segments that enable teaching of geometric shapes.

8. The system of claim 2 wherein said system includes:
said at least one component having segments that enable teaching of grooming skills.

9. The system of claim 2 wherein said system includes:
said at least one component having segments that enable teaching of telephone skills.

10. The system of claim 2 wherein said system includes:
said at least one component having segments that enable teaching of time telling skills.

11. The system of claim 1 wherein said system further includes:
said at least one component having features for improving dexterity of a child.

12. The system of claim 1 wherein said system further includes:
said at least one component having features for improving associative skills of a child.

13. A method for instructing young children in fundamentals including shapes, colors, numbers and alphabetic letters, said method comprising the steps of:
providing a toy for the enjoyment of a child at play; and
providing at least one component on said toy for providing visual, auditory and kinesthetic learning of at least one of said fundamentals to said child through interaction with another person.

14. The method of claim 13 wherein said step of providing at least one component on said toy for providing visual, auditory and kinesthetic learning of at least one of said fundamentals to said child through interaction with another person includes:
providing colored segments on said at least one component for teaching the primary colors to a child.

15. The method of claim 13 wherein said step of providing at least one component on said toy for providing visual, auditory and kinesthetic learning of at least one of said fundamentals to said child through interaction with another person includes:
providing colored segments on said at least one component for teaching secondary colors to a child.

16. The method of claim 13 wherein said step of providing at least one component on said toy for providing visual, auditory and kinesthetic learning of at least one of said fundamentals to said child through interaction with another person includes:
providing numbered segments on said at least one component for teaching numbers to a child.

17. The method of claim 13 wherein said step of providing at least one component on said toy for providing visual, auditory and kinesthetic learning of at least one of said fundamentals to said child through interaction with another person includes:
providing segments with the alphabet on said at least one component for teaching the alphabet to a child.

18. The method of claim 13 wherein said step of providing at least one component on said toy for providing visual, auditory and kinesthetic learning of at least one of said fundamentals to said child through interaction with another person includes:
providing shaped segments on said at least one component for teaching shapes to a child.

19. The method of claim 13 wherein said step of providing at least one component on said toy for providing visual, auditory and kinesthetic learning of at least one of said fundamentals to said child through interaction with another person includes:
providing removable segments on said at least one component for improving dexterity to a child.

20. The method of claim 13 wherein said step of providing at least one component on said toy for providing visual, auditory and kinesthetic learning of at least one of said fundamentals to said child through interaction with another person includes:
providing removable segments on said at least one component for teaching associative skills to a child.

21. The method of claim 13 wherein said step of providing at least one component on said toy for providing visual, auditory and kinesthetic learning of at least one of said fundamentals to said child through interaction with another person includes:
providing segments teaching more than one fundamental on said at least one component for teaching fundamentals to a child.

22. The method of claim 13 wherein said step of providing at least one component on said toy for providing visual, auditory and kinesthetic learning of at least one of said fundamentals to said child through interaction with another person includes:
providing features on said at least one component for teaching basic skills to a child.
